(19) United States
(12) Patent Application Publication
(10) Pub. No.: US 2003/0062729 A1
(43) Pub. Date: Apr. 3, 2003

(54) Reversible gravity gate latch

(76) Inventors: Corey J. Ottens, Morrison, IL (US); Cordell E. Meiste, Morrison, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/970,345

(22) Filed: Oct. 3, 2001

(51) Int. Cl. E05C 3/06

(52) U.S. Cl. 292/236

(57) ABSTRACT

A latch apparatus is provided for selectively securing a movable structure, such as, for example, a gate, to a fixed structure, such as, for example, a fence post. The latch apparatus includes a latching bar mounted to the one of the fixed structure and the movable structure, a latch case mounted to the other of the fixed structure and the movable structure, a latch lever pivotally mounted to the latch case, and a remote latch handle operatively connected to the latch lever. The remote latch handle is mounted to one of the fixed structure and the movable structure, and movable only in a substantially linear manner.

### BACKGROUND OF THE INVENTION

(a) Field of the Invention

The present invention relates generally to gate latches, and more particularly, to a gate latch mechanism that can be manually latched and/or unlatched from either of two sides of the gate or fence to which the gate latch mechanism is mounted.

(b) Description of Related Art

A common mechanism used to latch a gate, such as, for example a gate that is attached to an outdoor fence, includes a latch bar attached to the gate and a latch mechanism attached to a fixed structure, such as, a fence post. In order to facilitate opening and closing the gate, mechanisms have been developed that permit the user to open the gate from either side thereof (e.g., from the inside of an enclosure associated with the gate or the outside of such an enclosure).

Examples of such mechanisms can be found in U.S. Pat. Nos. 6,170,892, 6,058,747, 5,116,090, 5,498,041, 6,358,292, as well as in Australian Patent Application No. 25,197/35. In addition, a gate latch hardware kit marketed under the trademark “GateGear Hardware™,” includes a thumb latch pivotally attached to a latch lever.

### SUMMARY OF THE INVENTION

In accordance with one aspect of the present invention, a latch apparatus for selectively securing a movable structure to a fixed structure is provided. The latch apparatus includes a latching bar mounted to the one of the fixed structure and the movable structure, a latch case mounted to the other of the fixed structure and the movable structure, a latch lever pivotally mounted to the latch case, and a remote latch handle operatively connected to the latch lever. The remote latch handle is mounted to one of the fixed structure and the movable structure, and is movable only in a substantially linear manner.

In accordance with another aspect of the invention, a guide plate is mounted to the one of the fixed structure and the movable structure to which the remote latch handle is mounted. The guide plate secures the remote latch handle to the one of the fixed structure and the movable structure to which the remote latch handle is mounted. The guide plate may include a pair of elongate slanted channels that intersect one another, and the guide plate may also be symmetric about a horizontal axis.

### BRIEF DESCRIPTION OF THE DRAWINGS

FIG. 1 is a plan view of a gate latch mechanism in accordance with the present invention installed on a gate and a fence post;

FIG. 2 is a side view of a portion of the latch mechanism of FIG. 1, in an unlatched position;

FIG. 3 is a perspective view of the same portion of the latch mechanism shown in FIG. 2, in a latched position;

FIG. 4 is a rear view of a guide plate forming part of the latch mechanism of FIG. 1;

FIG. 5 is a perspective rear view of the guide plate of FIG. 4;

FIG. 6 is a perspective view of a backing plate forming part of the latch mechanism shown in FIG. 1; and

FIG. 7 is a perspective view of a remote latch handle forming part of the latch mechanism of FIG. 1.

### DESCRIPTION OF THE PREFERRED EMBODIMENT

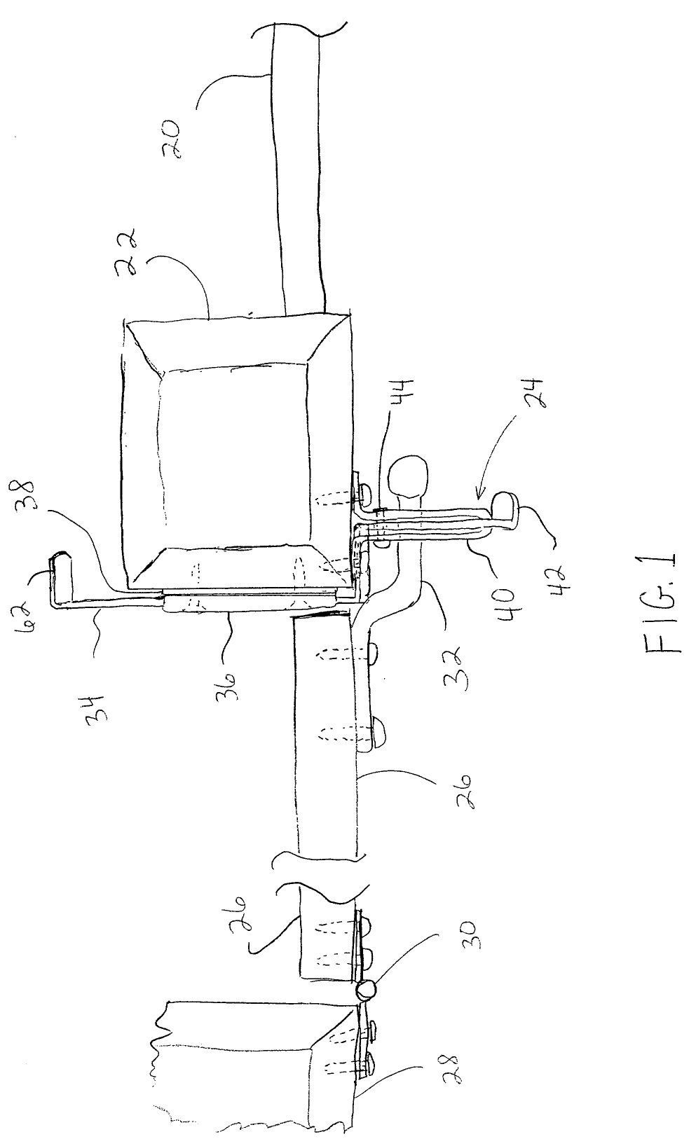

Referring initially to FIG. 1, a first fence section 20 is connected to a first fence post 22. A latch mechanism, generally indicated at 24, is attached to the first fence post 22. A gate 26 is attached to a second fence post 28 via a hinge mechanism 30. The latch mechanism 24 includes a latch bar 32 that is attached to the gate 26 and a remote latch handle 34, having a width w, is secured to the first fence post 22 by being sandwiched between a guide plate 36 and a backing plate 38 such that the remote latch handle 34 may slide only in a substantially linear manner along its length with respect to the first fence post 22. The guide plate 36 and the backing plate 38 may be constructed of any suitable material, such as, for example, injection molded plastic. The remainder of the latch mechanism 24 may also be constructed of any suitable material, such as, for example, a metal such as steel, or a high strength plastic or composite material. The latch mechanism 24 further includes a latch case 40 secured to the first fence post 22 and a primary latch lever 42 that is pivotally connected to the latch case 40 by a rivet 44.

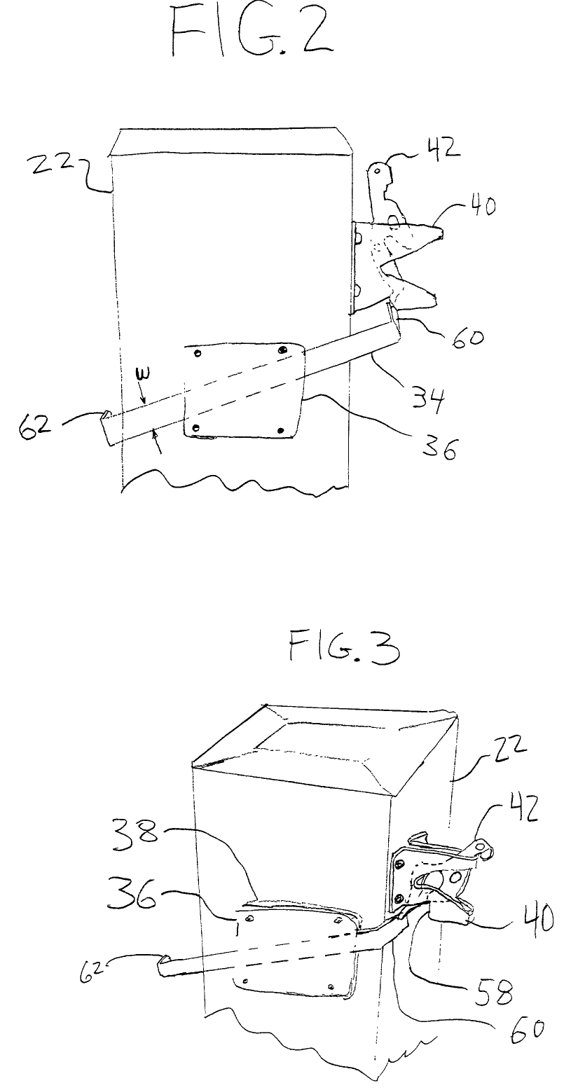

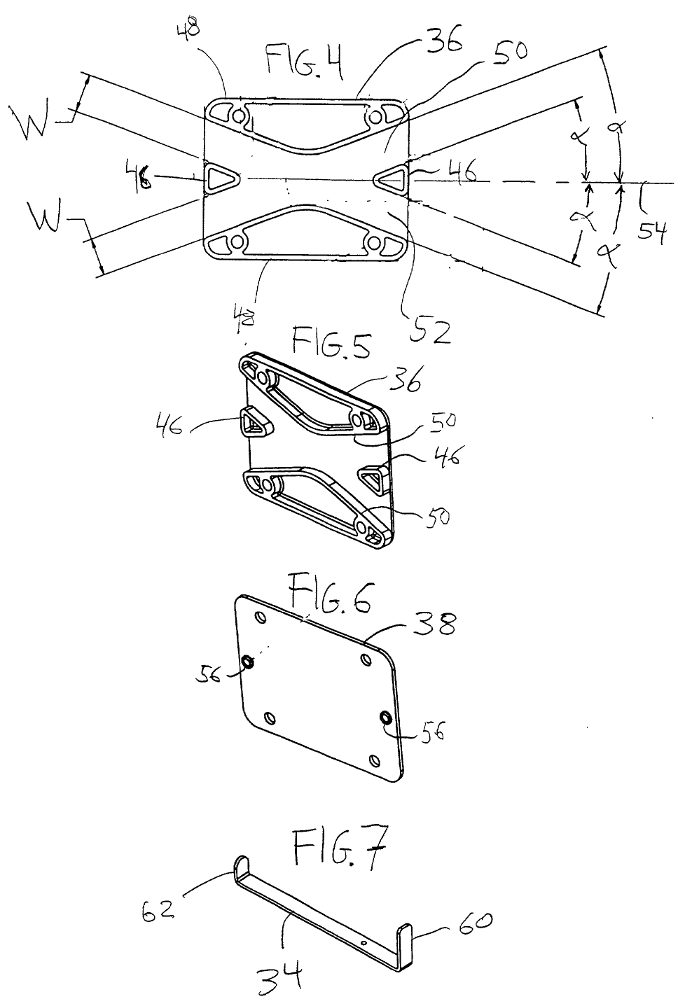

As best seen in FIGS. 2 and 3, the remote latch handle 34 is mounted in an inclined fashion in order to ensure that the upper end of the remote latch handle 34 will normally slide toward the first fence post 22 due to the force of gravity. This inclined mounting is facilitated by the geometry of the guide plate 36, which is best seen in FIGS. 4 and 5. The guide plate 36 includes a pair of small triangular boss members 46 and a pair of large triangular boss members 48. The spacing of parallel surfaces of the boss members 46 and 48 define a pair of slanted channels 50 and 52 therebetween, each having a width W, which is slightly larger than the width w of the remote latch handle 34, to insure that the remote latch handle 34 will be guided to move only in a substantially linear manner. A center line 54 of the guide plate 36 is aligned with the horizontal when the guide plate 36 is mounted to the first fence post 22. Each of the slanted channels 50 and 52 is angularly displaced from the center line 54 of the guide plate 36 by an angle α, which may be, for example, about 20°, or any angle from about 15° to about 45°. In order to accommodate either a left or right handed gate configuration, the remote latch handle 34 may simply be installed to slide within either the channel 50 or the channel 52, as appropriate.

The backing plate 38, depicted in isolation in FIG. 6, includes a pair of circular bosses 56 that are positioned and sized such that the circular bosses 56 fit into the interior of each of the small triangular boss members 46 on the guide plate 36. The backing plate 38 is not a necessary component of the latch mechanism 24 when the latch mechanism is used in conjunction with the fence post 22 if the fence post 22 is constructed of a material such as PVC plastic, or another generally smooth-surfaced, durable material. However, the backing plate 38 is a desirable component of the latch mechanism 24 when the fence post 22 is constructed of wood, painted metal, or the like, that may be subject to wear due to the movement of the remote latch handle 34. In addition, the backing plate 38 ensures smooth operation of the remote latch handle 34.

With reference again to FIG. 3, it should be noted that the latch case 40 includes a notch 58 that is engaged by a first end flange 60 of the remote latch handle 34 (shown in FIG. 7), when the latch mechanism 24 is in the unlatched position. The remote latch handle 34 also includes a second end flange 62 adapted to abut the first fence post 22 when the latch mechanism 24 is in the unlatched position. The flanges 60 and 62 prevent the remote latch handle 34 from falling out of the slanted slot 50.

In order to unlatch the latch mechanism 24, one may either directly pivot the primary latch handle 42, or push the second end flange 62 of the remote latch handle 34 in a substantially linear manner toward the latch mechanism 24 in order to push the lower end of the primary latch handle 42 away from the first fence post 22. This substantially linear movement of the remote latch handle 34 is intuitive to the gate operator, because it is in the same direction of pushing the gate 26 open, and is much preferred to the more unnatural and complex curved travel that may prior art units require for the operator's hand to go through. Such linear travel of the remote latch handle 34 and will cause the primary latch handle 42 to pivot about the rivet 44 to the unlatched position, as shown in FIG. 2. Once the second end flange 62 is released, the latch handle 34 will slide back to its lowest normal position, under the force of gravity, i.e., to the position shown in FIG. 3, wherein the first end flange 60 abuts the first fence post 22.

It should be noted that the guide plate 36 is symmetric about the axis 54, such that the guide plate 36 is reversible and may be installed on either the left hand side or the right hand side of the fence post 22, depending on the configuration of the gate 26 (i.e., whether the gate is hinged such that it is in a “left handed” or “righted handed” configuration during opening). The U-shaped geometry of the remote latch handle 34 also makes it usable in either a “left handed” or “righted handed” configuration. Thus, the invention provides a gate latch apparatus having a simple, cost effective structure with a minimum number of parts that are easy to manufacture, and which provides the versatility to be installed in a number of different configurations (e.g., left or right handed; latch bar on gate or on fixed post) without the need for additional parts.

While the present invention has been described with reference to specific examples, which are intended to be illustrative only, and not to be limiting of the invention, as it will be apparent to those of ordinary skill in the art that changes, additions and/or deletions may be made to the disclosed embodiments without departing from the spirit and scope of the invention. For example, the materials used for constructing the gate latch in accordance with the invention could be varied without departing from the spirit and scope of the invention. It should also be noted that the notch 58 could be formed in an existing gate latch mechanism, for example, by cutting or filing the notch 58 into the existing gate latch mechanism, and the existing mechanism could then be retrofitted to include the remote latch handle 34, the guide plate 36, and the backing plate 38.

What is claimed is:

1. A latch apparatus for selectively securing a movable structure to a fixed structure, the latch apparatus comprising:
a latching bar mounted to the one of said fixed structure and said movable structure;
a latch case mounted to the other of said fixed structure and said movable structure;
a latch lever pivotally mounted to said latch case; and
a remote latch handle operatively connected to said latch lever, mounted to one of said fixed structure and said movable structure, and movable only in a substantially linear manner.

2. The latch apparatus of claim 1, further including a guide plate, mounted to said one of said fixed structure and said movable structure to which said remote latch handle is mounted, and that secures said remote latch handle to said one of said fixed structure and said movable structure to which said remote latch handle is mounted.

3. The latch apparatus of claim 2, wherein said guide plate includes an elongate channel.

4. The latch apparatus of claim 3, wherein said elongate channel is slanted.

5. The latch apparatus of claim 4, wherein said elongate channel has a slant angle of about 20°.

6. The latch apparatus of claim 2, wherein said guide plate includes a pair of elongate channels.

7. The latch apparatus of claim 6, wherein each of said pair of elongate channels is slanted.

8. The latch apparatus of claim 7, wherein said pair of elongate channels intersect one another.

9. The latch plate apparatus of claim 8, wherein said guide plate has a horizontal axis of symmetry.

10. The latch apparatus of claim 2, further including a backing plate, and wherein said remote latch handle is mounted between said guide plate and said backing plate.

11. The latch apparatus of claim 1, wherein said remote latch handle is movable in said substantially linear manner between a first position out of engagement with said latch lever, and a second position in engagement with said latch lever.

12. A latch apparatus for selectively securing a movable structure to a fixed structure, the latch apparatus comprising:
a latching bar mounted to the one of said fixed structure and said movable structure;
a latch case mounted to the other of said fixed structure and said movable structure;
a latch lever pivotally mounted to said latch case;
a remote latch handle operatively connected to said latch lever, mounted to one of said fixed structure and said movable structure, and movable only in a substantially linear manner; and
means for guiding said remote latch handle.

13. The latch apparatus of claim 12, wherein said guiding means includes an elongate channel.

14. The latch apparatus of claim 13, wherein said elongate channel is slanted.

15. The latch apparatus of claim 14, wherein said elongate channel has a slant angle of from about 15° to about 45°.

16. The latch apparatus of claim 12, wherein said guiding means includes a pair of elongate channels.

17. The latch apparatus of claim 16, wherein each of said pair of elongate channels is slanted.

18. The latch apparatus of claim 17, wherein said pair of elongate channels intersect one another.

19. The latch plate apparatus of claim 18, wherein said guiding means has a horizontal axis of symmetry.

20. The latch apparatus of claim 12, further including a backing plate, and wherein said remote latch handle is mounted between said guiding means and said backing plate.

21. The latch apparatus of claim 12, wherein said remote latch handle is movable between a first position out of engagement with said latch lever, and a second position in engagement with said latch lever.
